(19) United States
(12) Patent Application Publication
(10) Pub. No.: US 2022/0027860 A1
(43) Pub. Date: Jan. 27, 2022

(54) RENTAL SPACE

(71) Applicant: TAISHO SKY BUILDING, INC., Tokyo (JP)

(72) Inventor: Kazuharu ISHIDA, Tokyo (JP)

(73) Assignee: Taisho Sky Building, Inc.

(21) Appl. No.: 17/450,689

(22) Filed: Oct. 12, 2021

Related U.S. Application Data
(63) Continuation of application No. PCT/JP2019/015796, filed on Apr. 11, 2019.

(51) Int. Cl. G06Q 10/10; G06Q 10/06; G06Q 30/06; G06Q 30/02

(52) U.S. Cl. CPC G06Q 10/1095; G06Q 30/0206; G06Q 30/0645; G06Q 10/06314

(57) ABSTRACT

A host device receives, from a first terminal device, first reservation information including a reservation date, a reservation time, and a number of people; allocates a first rental space based on the first reservation information without sending a notification identifying the first rental space to the first terminal device before a change period elapses; receives, from the first terminal device, updated reservation information; allocates a second rental space based on the updated reservation information without sending a notification identifying the second rental space to the first terminal device before the change period elapses; and upon elapse of the change period sends a notification identifying the second rental space to the first terminal device.

### RELATED APPLICATIONS

The present application is a continuation of International Patent Application No. PCT/JP2019/015796, filed Apr. 11, 2019, which is hereby incorporated by reference in its entirety.

### TECHNICAL FIELD

This disclosure relates to a reservation system for setting a usage time and reserved space to a user.

### BACKGROUND

A system for renting empty conference rooms of a building (e.g., an office, a hotel, or the like) to users typically includes a management server open to a communication network such as the Internet, and a plurality of reservation servers in which information on the conference room is stored. Such a system is typically configured so that users can access information describing the conference room in a reservation server via the management server and reserve a desired conference room. Such a system also typically has a billing function so that a rental fee can be paid online.

### SUMMARY

Implementations of a reservation system (also referred to as a rental space) as described herein include a reservation system in which a usage time is set and the space is rented to a user, including: a management device (also referred to as a host device) that is connected to a communication link to manage information; a user input unit that is connected to the management device via the communication link and receives information input from the user to the management device; and a notification unit that is connected to the management device via the communication link and notifies the user of predetermined information of the management device, in which the management device includes: a control unit that controls a function related to rental of the space; a date and time storage that stores date and time information including a reservation date and time to use the space; a number of people storage that stores number of people information including the number of users who use the space; and an allocation storage that stores allocation information of the space. The control unit stores the date and time information in the date and time storage and stores the number of people information in the number of people storage on the basis of information input from the user input unit, sets the allocation information on the basis of the date and time information and the number of people information, and generates a notification command for causing the notification unit to notify the set allocation information. The notification unit notifies the user of the allocation information on the basis of the notification command transmitted from the control unit via the communication link.

In some implementations, the control unit of the management device stores the date and time information and the number of people information on the basis of the information input from the user input unit, sets the allocation information on the basis of the date and time information and the number of people information, and generates a notification command for causing the notification unit to notify the set allocation information, and the notification unit notifies the user of the allocation information on the basis of the notification command, so that it is possible to receive input (new input, change, update) of the number of users and date and time of use from the user, and allocate a space of an appropriate size according to the number of users. Therefore, the user does not have to intentionally limit the size of the space and the number of users at the time of reservation, and even when the number of users is unpredictable, the user can reserve the space relatively easily, and even when the number of users changes, it is also possible to improve user satisfaction per rental transaction by allocating the space of the appropriate size, thereby decreasing the opportunity loss. Thus, it is possible to improve the operational efficiency of the reservation system by receiving a positive reservation from the user and expecting an increase in the number of users who repeatedly use the reservation system due to improvement of user satisfaction.

In some implementations, the control unit includes a space allocator that allocates at least a part of all available space on the basis of the date and time information, the number of people information, and the allocation information, and the space allocator inputs the allocation information on the allocated space into the allocation storage to update the allocation information.

With such a configuration, the control unit includes a space allocator that allocates at least a part of all available space, and the space allocator automatically allocates the space on the basis of the date and time information, the number of people information, and the allocation information, so that labor costs can be reduced compared to manually allocating the space, and when the reservation is received or when the reservation is changed, the allocation information can be immediately updated to be notified to the user.

In some implementations, the control unit includes a fee calculator for calculating a rental fee for the space to be rented, and the fee calculator calculates the rental fee by multiplying the number of users by a predetermined amount.

With such a configuration, the control unit includes the fee calculator for calculating the rental fee for the space to be rented, and the fee calculator calculates the rental fee according to the number of users by calculating the rental fee by multiplying the number of users by the predetermined amount, so that the user can make a use schedule according to the rental fee.

In some implementations, the control unit includes an allocation rate calculator for calculating an allocation rate, which is a ratio of the already allocated space to an entire space, from the allocation information, and the fee calculator increases a predetermined amount to be multiplied by the number of users when the allocation rate is high, and decreases the predetermined amount to be multiplied by the number of users when the allocation rate is low, to calculate the rental fee.

With such a configuration, the control unit includes the allocation rate calculator for calculating the allocation rate, and the fee calculator changes the rental fee according to the number of users and the allocation rate, so that it is possible to automatically change the rental fee according to a reservation status of the entire space, thereby balancing supply and demand.

In some implementations, the reservation system includes a partition unit that is connected to the management device via the communication link and partitions the space, in which the control unit generates a partition command related to the space to be rented from the allocation information, and the partition unit partitions a space allocated to the user out of the entire space on the basis of the partition command transmitted from the control unit.

According to such a configuration, the reservation system includes the partition unit that is connected to the management device via the communication link and partitions the space, the control unit generates the partition command related to the space to be rented from the allocation information, and the partition unit partitions the space allocated to the user out of the entire space on the basis of the partition command, so that the partition unit automatically allocates a part of the entire space to the user to partition the space, and thus it is possible to provide the user with the space of the appropriate size while reducing costs such as labor costs.

In some implementations, with respect to a reserved existing reservation in which the date and time information is stored in the date and time storage and the number of people information is stored in the number of people storage, the control unit receives information input from a new user who applies for participation in the existing reservation, and updates the number of people information stored in the number of people storage on the basis of the information input.

According to such a configuration, with respect to the existing reservation that has already been reserved, the control unit receives a participation application from the new user and updates the number of people information in the number of people storage, so that it is possible to flexibly respond to a change in the number of users. That is, when an organizer (the user) of a lecture or a seminar makes the reservation at the time of new reservation, and then a participant (the new user) who wishes to participate in the lecture or the seminar applies for participation, it is not necessary for the organizer who receives the participation application to input a change in the number of people, and the control unit directly receives the participation application from the participant and updates the number of people information, so that it is possible to reduce time and effort of the organizer in reservation input.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a schematic configuration diagram of a reservation system in accordance with some implementations.

FIG. 2 is a block diagram illustrating a configuration of a management device for the reservation system in accordance with some implementations.

FIG. 3 is a flowchart illustrating operations of the management device for the reservation system in accordance with some implementations.

FIG. 4 is a schematic configuration diagram illustrating a modification of the reservation system in accordance with some implementations.

### DETAILED DESCRIPTION

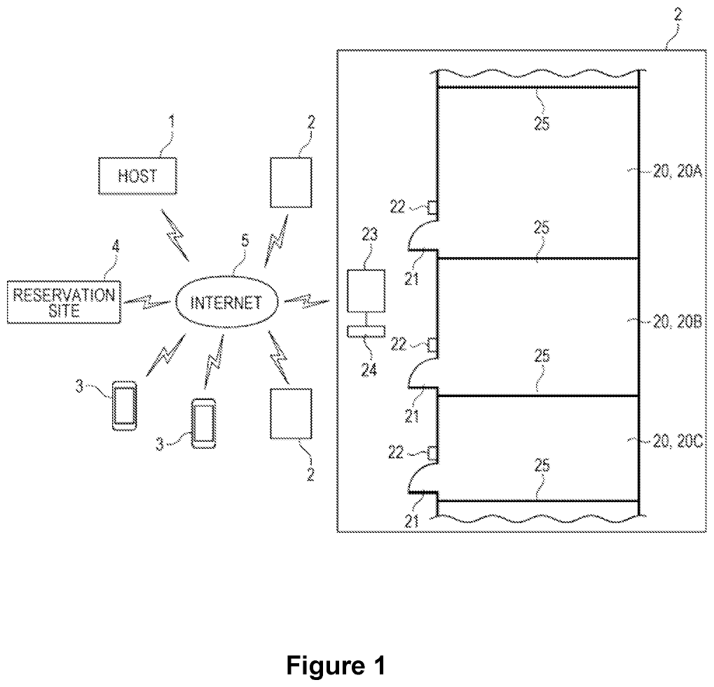

FIG. 1 is a schematic configuration diagram of a reservation system in accordance with some implementations.

As illustrated in FIG. 1, the reservation system includes a host 1 which is a management device for managing the reservation system, and a plurality of rooms 20 which are spaces for renting to users, and there is a plurality of buildings 2 having the plurality of rooms 20. The host 1, the buildings 2, terminal devices 3 such as a mobile phone, a smart phone, and a personal computer owned by the user, and a reservation site 4 for reserving a rental of the room 20 can be connected to each other via the Internet 5 which is a public network as a communication link. The user can access the reservation site 4 via the Internet 5 using the terminal device 3 as a user input unit, search for the room 20 according to a purpose, and specify a usage time and the number of users, to perform a reservation. When the reservation site 4 receives the reservation from the user, the reservation site 4 transmits reservation information including the room 20 for which the reservation has been established and a reservation time to the host 1. The host 1 transmits allocation information of the room 20 set on the basis of the reservation information to the terminal device 3 as a notification unit to notify the user.

The building 2 includes the rooms 20 such as a conference room and a training room, and each room 20 is provided with a doorway 21 and a locking device 22 for locking and unlocking the doorway 21. The locking device 22 can be unlocked by an authentication key such as a password or a bar code issued from the reservation site 4 to the terminal device 3 of the user, and the authentication key is randomly changed each time it is used, so that only the user who made a reservation at that time can unlock the locking device 22 by using a unique authentication key. A communication terminal device 23 such as a modem or a router is connected to each room 20 via a local area network (LAN), and the communication terminal device 23 is connected to the host 1 via the Internet 5. Further, an electronic bulletin board 24 as the notification unit is connected to the communication terminal device 23. The electronic bulletin board 24 has a display device such as a liquid crystal monitor, and displays the allocation information of each room 20 on the basis of a notification command from the host 1 to notify the user. The rooms 20 are partitioned by partition walls 25, and there are a relatively large room 20A (for example, a capacity of 15 to 25 people), a room 20B having an intermediate size (for example, a capacity of 10 to 18 people), and a relatively small room 20C (for example, a capacity of 5 to 12 people).

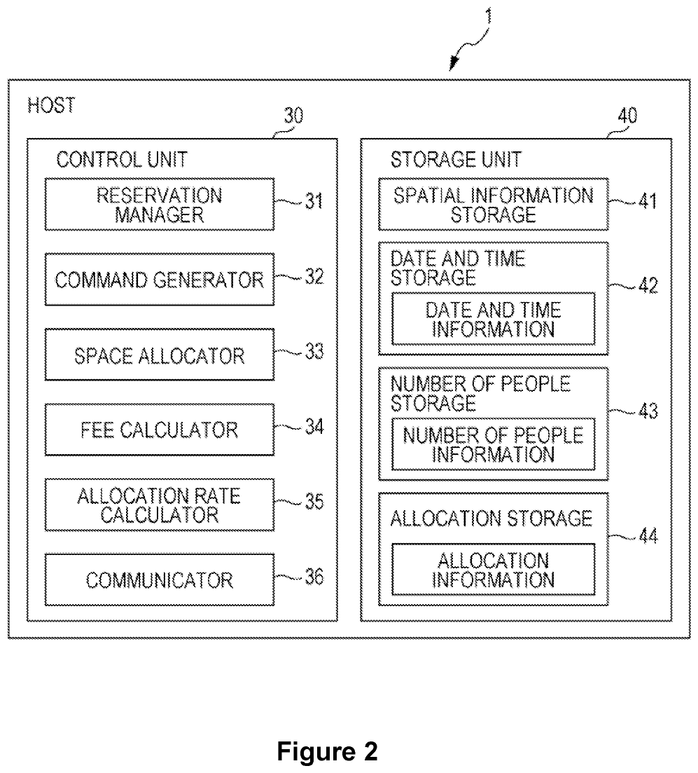

FIG. 2 is a block diagram illustrating a configuration of a management device for the reservation system in accordance with some implementations.

The host 1, which is the management device for the reservation system, may be implemented as a server. The host 1 includes a control unit 30 (e.g., a central processing unit (CPU) or the like), and a storage unit or device 40 (e.g., a hard disk drive (HDD) or other memory). The control unit 30 includes a reservation manager 31 that manages the reservation information reserved by the user via the reservation site 4, a command generator 32 that generates various commands such as a notification command for the notification unit, a space allocator 33 that allocates the room 20 to be rented on the basis of the reservation information, a fee calculator 34 that calculates a rental fee of the room 20 to be rented, an allocation rate calculator 35 that calculates an allocation rate which is a ratio of the rooms 20 that have already been allocated out of all the rooms 20 from the allocation information, and a communicator 36 that controls communication with the communication terminal device 23, the reservation site 4, and the terminal device 3 of the user.

The storage unit 40 includes a spatial information storage 41 that stores information of all the rooms 20 to be managed, a date and time storage 42 that stores date and time information including a reservation date and time for using the room 20, a number of people storage 43 that stores the number of people information including the number of users who use the room 20, and an allocation storage 44 that stores the allocation information of the room 20. When the reservation manager 31 receives the reservation from the user, the control unit 30 causes the date and time storage 42 to store the date and time information on the basis of the reservation information and the information of all the rooms 20 stored in the spatial information storage 41, and causes the number of people storage 43 to store the number of people information. Further, the control unit 30 causes the space allocator 33 to allocate the room 20 to be rented, causes the allocation storage 44 to store the allocation information of the room 20, causes the allocation rate calculator 35 to calculate the allocation rate from the allocation information, and causes the fee calculator 34 to calculate the rental fee of the room 20 on the basis of the allocation rate. When the date and time information, the number of people information, the allocation information, and the rental fee are determined for the received reservation information, the control unit 30 causes the command generator 32 to generate the notification command for notifying the allocation information and the rental fee, and transmits the notification command to the terminal device 3 of the user by the communicator 36.

Note that the reservation manager 31, the command generator 32, the space allocator 33, the fee calculator 34, the allocation rate calculator 35, and the communicator 36 may be executed as a program by the CPU of the server, may be configured by independent devices, or may be configured using cloud computing. Further, the storage unit 40 may be configured by the storage device (e.g., an HDD), or may use a storage unit of a cloud service. Further, the terminal device 3 that functions as the user input unit and the notification unit may be a device such as a smartphone including an input unit that receives input from the user, a display for notifying the user of information, a communicator for transmitting and receiving information to and from the host 1, and a controller that controls the input unit, the display, the communicator, and the like, or may be a device in which the input unit, the display, the communicator, and the controller are configured by independent devices.

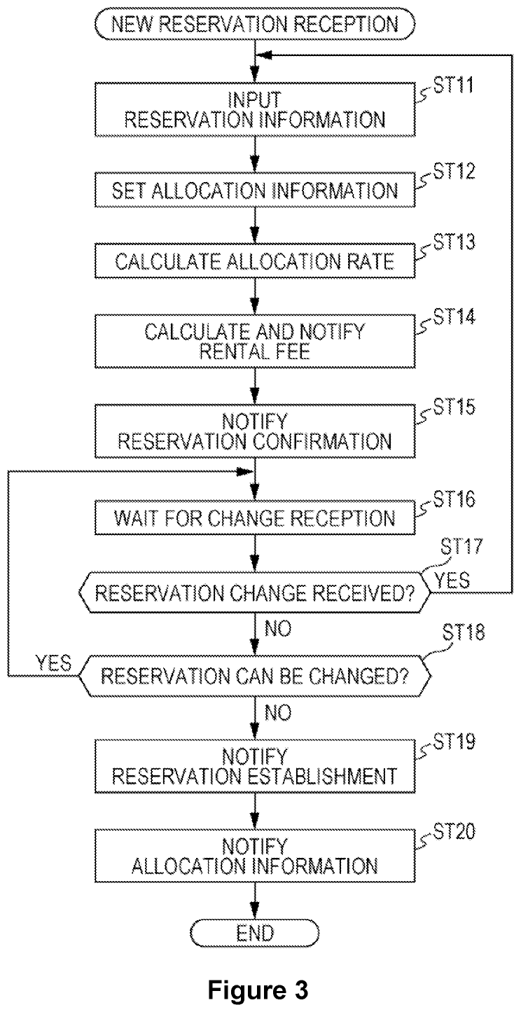

FIG. 3 is a flowchart illustrating operations of the management device for the reservation system in accordance with some implementations.

The flowchart of FIG. 3 illustrates an operation procedure of the host 1 after receiving a new reservation by the user. When the reservation manager 31 receives the reservation from the reservation site 4, the control unit 30 of the host 1 causes the data and time storage 42 to stores the date and time information on the basis of the reservation information, and causes the number of people storage 43 to store the number of people information (Step ST11). Subsequently, the control unit 30 causes the space allocator 33 to set the allocation information of the room 20 to be rented on the basis of the reservation information and the information of all the rooms 20 stored in the spatial information storage 41, and causes the allocation storage 44 to store the allocation information (allocation information setting step: Step ST12). Specifically, the space allocator 33 extracts a room 20 that is vacant at a time of the date and time information and has a size suitable for the number of people information, from all the rooms 20 stored in the spatial information storage 41, and sets the allocation information to allocate the extracted room 20. Note that if there is no room 20 that matches the date and time information and the number of people information, the control unit 30 causes the command generator 32 to generate a nonconformity command, and causes the communicator 36 to transmit the nonconformity command to the terminal device 3 of the user.

Here, when a new reservation for 16 users is received, if both a room 20A (capacity 15 to 25 people) and a room 20B (capacity 10 to 18 people) are vacant, the space allocator 33 allocates, for example, the room 20B, sets the allocation information, and causes the allocation storage 44 to store the allocation information. At this time, when the reservation prior to the new reservation is allocated to the room 20B, if the number of users of the prior reservation is smaller than the number of users (16 people) of the new reservation, the space allocator 33 allocates the room 20A to the new reservation. On the other hand, if the number of users of the prior reservation is larger than the number of users (16 people) of the new reservation, the space allocator 33 allocates the room 20B for the new reservation and changes the allocation of the prior reservation from the room 20B to the room 20A. Even if there is such a change in the allocation information of the room 20, it is not necessary to notify the user having the prior reservation of the change of the room 20. That is, since it is sufficient to allocate the room 20 having an appropriate size to the user on the basis of the number of users, it is not necessary to notify the user of the specific rooms 20A to C or the like.

Subsequently, the control unit 30 causes the allocation rate calculator 35 to calculate the allocation rate from the set allocation information (allocation rate calculation step: Step ST13). Specifically, the allocation rate calculator 35 calculates the allocation rate which is the ratio of the rooms 20 already allocated out of all the rooms 20. Subsequently, the control unit 30 causes the fee calculator 34 to calculate the rental fee of the allocated room 20, causes the command generator 32 to generate the notification command on the basis of the calculated rental fee, and causes the communicator 36 to transmit the notification command to the terminal device 3 of the user (rental fee calculation/notification step: Step ST14). Specifically, the fee calculator 34 calculates the rental fee by multiplying the number of users by a predetermined amount, and when the allocation rate is high, the predetermined amount to be multiplied by the number of users is increased, and when the allocation rate is low, the predetermined amount to be multiplied by the number of users is decreased, to calculate the rental fee. Here, when the user checks the rental fee notified by the terminal device 3, and sends a response to cancel a reservation application from the terminal device 3, and when the control unit 30 receives this cancellation notice, the control unit 30 ends a process. On the other hand, when the user sends a response to accept the rental fee from the terminal device 3 and the control unit 30 receives this acceptance notification, the control unit 30 causes the command generator 32 to generate a reservation confirmation notification command, and causes the communicator 36 to transmit this notification command to the terminal device 3 of the user (reservation confirmation notification step: Step ST15).

When the reservation of the room 20 is established as described above, the control unit 30 is in a standby state of waiting for change reception of the reservation (change reception standby step: Step ST16). In the change reception standby step, the reservation manager 31 of the control unit 30 checks at predetermined intervals whether there is an input for the reservation change from the reservation site 4. The control unit 30 checks whether the reservation manager 31 has received the reservation change from the reservation site 4 (reservation change reception step: Step ST17), and when the reservation change is received (YES in Step ST17), the control unit 30 performs the above-mentioned Steps ST11 to ST15, updates the date and time information, the number of people information, and the allocation information on the basis of the changed reservation information, and notifies the user of the allocation information. Here, when the number of users is changed, for example, when the reservation change of the number of users increasing from 16 to 22 is received, the space allocator 33 changes the room 20B to the room 20A, allocates the space 20A, sets the allocation information, and causes the allocation storage 44 to store the allocation information. Even if the room 20 is changed in this way, it is not necessary to notify the user that the room has been changed, as described above.

On the other hand, when there is no input for changing the reservation (NO in Step ST17), the control unit 30 determines whether the reservation can be changed (reservation changeability determination step: Step ST18). As for whether the reservation can be changed, for example, it is determined that the reservation can be changed if it is before a time (for example, noon on the day before the reservation date) when the reservation can be changed, and it is determined that the reservation cannot be changed after the time when the reservation can be changed. When it is determined that the reservation can be changed (YES in Step ST18), the control unit 30 returns to the change reception standby step (Step ST16) and repeats Steps ST17 and ST18. Note that even if one reservation is in a state of waiting for the change reception, the room 20 allocated to the one reservation may also be changed by allocation of the room 20 for another new reservation or the reservation change. Also in this case, the space allocator 33 only causes the allocation storage 44 to store the changed allocation information, and it is not necessary to notify the user of the one reservation that the change has occurred.

When it is determined that the reservation cannot be changed (NO in Step ST18), the control unit 30 causes the reservation manager 31 to establish the reservation information, causes the command generator 32 to generate the notification command that the reservation is established and cannot be changed, and causes the communicator 36 to transmit the notification command to the terminal device 3 of the user (reservation establishment notification step: Step ST19). Further, the control unit 30 causes the command generator 32 to generate the notification command of the reservation establishment, and causes the communicator 36 to transmit the notification command of the allocation information that the reservation is established to the terminal device 3 of the user and the communication terminal device 23 in the building 2 (allocation information notification step: step ST20). The terminal device 3 of the user that has received the notification command notifies the user of the allocation information. Here, the allocation information of the room 20 displayed on the terminal device 3 only needs to include at least the reservation time and building information, and does not need to include a floor number and a room number of the room 20. Further, the electronic bulletin board 24 displays the allocation information of the room 20 at a predetermined time on the day of use, thereby notifying the visiting user of the allocation information of the room 20. Here, the allocation information of the room 20 displayed on the electronic bulletin board 24 also includes the floor number and the room number of the room 20, so that the visiting user can recognize the room 20 where the reservation has been established.

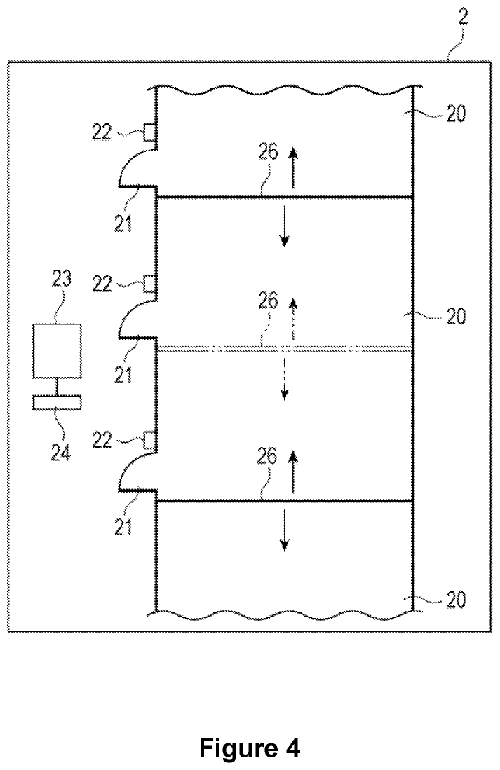

FIG. 4 is a schematic configuration diagram illustrating a modification of the reservation system in accordance with some implementations.

Note that in the present implementation, each room 20 may be partitioned by movable partition walls 26 as partition units, as illustrated in FIG. 4. The movable partition wall 26 is configured to be movable by a driving unit (not illustrated), and the size of each room 20 is changed by moving the movable partition wall 26. The driving unit of the movable partition wall 26 is connected to the host 1 via the communication terminal device 23 and the Internet 5, and by moving the movable partition wall 26 on the basis of the partition command from the host 1, the size of each room 20 is set on the basis of the allocation information of each room 20. When it is necessary to change the size of the room 20, the control unit 30 causes the command generator 32 to generate the partition command for the room 20 on the basis of the allocation information, and causes the communicator 36 to transmit the partition command to the communication terminal device 23 in the building 2. The movable partition wall 26 of the building 2 is moved by the driving unit at an appropriate time (non-use time such as at night) on the basis of the partition command, whereby the size of the room 20 is changed.

According to such an implementation, the following operations and effects can be obtained.

(1) When the control unit 30 of the host 1 receives the input of the reservation information from the user, the control unit 30 stores the date and time information and the number of people information in the storage unit 40 on the basis of the reservation information, and the space allocator 33 sets the allocation information on the basis of the date and time information and the number of people information. Further, upon receiving a change in the number of users or date and time of use from the user, the control unit 30 updates the date and time information and the number of people information, and the space allocator 33 changes the allocation information, and allocates another room 20 or change the size of the room 20 to be allocated. According to this, the user does not have to intentionally limit the size of the room 20 and the number of users at the time of reservation, and even if the number of users is unpredictable, the user can relatively easily reserve the room 20, and even if the number of users changes, a room 20 having an appropriate size is allocated, so that it is possible to improve user satisfaction per rental transaction, thereby decreasing opportunity loss. Therefore, it is possible to improve operational efficiency of the reservation system by receiving a positive reservation from the user and expecting an increase in the number of users who repeatedly use the reservation system due to improvement of user satisfaction.

(2) The control unit 30 causes the command generator 32 to generate the notification command on the basis of the allocation information set or changed by the space allocator 33, and causes the communicator 36 to transmit the notification command to the terminal device 3 of the user, so that the allocation information can be notified to the user. Therefore, the user can confirm the reservation, so that convenience can be improved.

(3) The space allocator 33 of the control unit 30 manually allocates the appropriate room 20 from all the available rooms 20 on the basis of the date and time information, the number of people information, and the allocation information, so that it is possible to reduce labor costs compared to a case where the room 20 is manually allocated, and when the reservation is received or when the reservation is changed, the allocation information can be updated immediately and notified to the user.

(4) The fee calculator 34 of the control unit 30 calculates the rental fee of the room 20 to be rented by multiplying the number of users by the predetermined amount, and transmits and notifies the rental fee to the terminal device 3 of the user, so that the user can make a use schedule according to the rental fee. At this time, the fee calculator 34 of the control unit 30 changes the rental fee according to the allocation rate calculated by the allocation rate calculator 35, so that it is possible to automatically change the rental fee according to a reservation status of all the rooms 20, thereby balancing supply and demand.

(5) As illustrated in FIG. 4, if the room 20 of the reservation system is configured so that the size can be changed by the movable partition walls 26, the control unit 30 generates the partition command related to the room 20 to be rented from the allocation information, and partitions the room 20 allocated to the user by the movable partition wall 26 on the basis of the partition command, so that a part of all the rooms 20 is automatically allocated to the user to partition the room 20, and thus it is possible to provide the user with the room 20 having an appropriate size while reducing costs such as labor costs.

### Modified Implementations

Note that the inventive concepts described herein are not limited to the above implementations, and modifications, improvements, and the like within the range in which the object of the inventive concepts can be achieved are included in the present implementations.

For example, in the above implementations, a case in which the room 20 of building 2 is rented as the reservation system is exemplified, but the reservation system is not limited to a conference room, a training room, and the like, and may be a tennis court, a baseball field, a stadium, a parking lot, or the like, which are outdoor spaces, or a karaoke room, a rental office, a reading space, or the like.

In the above implementations, a case where the host 1 as a management device (e.g., a server) connected to the terminal device 3 and to the communication terminal device 23 via the Internet 5 which is the communication link is exemplified, but the management device is not limited to that including such a centralized management type server. That is, the management device may be a distributed management type device, for example, a device using a distributed transaction ledger typified by blockchain can be used, and any device that can manage the reservation information, and send and receive various commands to and from the terminal device 3 and the communication terminal device 23 can be used. Further, in the above implementations, the host 1 as the management device and the reservation site 4 are separately provided and connected to each other via the Internet 5, but the implementations described herein are not limited to this, and the host 1 and the reservation site 4 may be provided in a single site, or the function of the management device and the function of the reservation site may be implemented by a plurality of devices distributed on the Internet.

In the above implementations, the control unit 30 includes the space allocator 33, and the space allocator 33 automatically updates the allocation information, but the allocation information may be manually updated by an administrator or the like without automatically updating the allocation information by the space allocator 33. Further, the control unit 30 includes the fee calculator 34 for calculating the rental fee of the room 20 to be rented and the allocation rate calculator 35 for calculating the allocation rate, but the rental fee may be calculated manually. Furthermore, the fee calculator 34 calculates the rental fee by multiplying the number of users by the predetermined amount, but is not limited to this, the rental fee may be calculated by multiplying an area of the room 20 by a predetermined amount, or a method of calculating the rental fee may be changed according to a usage time zone.

In the above implementations, as the partition unit for partitioning the room 20 of the reservation system, as illustrated in FIG. 4, one movable partition wall 26 sliding as a whole is illustrated, but is not limited to this, the partition unit may include a plurality of walls so that each wall can be moved and separated and connected, or the partition unit may include shutter-type walls installed at a plurality of locations on the ceiling, which can be opened and closed up and down. Further, the partition unit is not limited to one driven by the driving unit, and may be a manual type one in which each room 20 is partitioned by a person such as an administrator. Further, the control unit 30 generates the partition command related to the room 20 to be rented from the allocation information, and the movable partition wall 26 partitions the room 20 on the basis of the partition command, but is not limited to this, the movable partition wall 26 may be automatically or manually moved to partition the room 20 on the basis of the allocation information. Furthermore, when updating the allocation information according to the change in the number of users, the space allocator 33 of the control unit 30 allocates a part of all space in the same building 2 or changes the size of the space and allocates the space by the partition unit, but is not limited to this, the space of another building 2 existing in the vicinity may be allocated. As such another building 2, an owner and an administrator may be the same or different, and it may be an operation form in which a plurality of owners (administrators) cooperates to rent the space of the building 2.

Further, in the above implementations, the user who applies for the reservation from the terminal device 3 which is the user input unit may be an organizer of a lecture or seminar, or a participant who participates in a lecture, seminar, or the like. Further, when recruiting participants through a customer attraction site or the like for a reserved existing reservation in which the organizer (user) newly applies and the date and time information is stored in the date and time storage 42 and the number of people information is stored in the number of people storage 43, the control unit 30 may receive the information input from a participant (new user) who applies for participation, and update the number of people information stored in the number of people storage 43 on the basis of the information input. At this time, an upper limit of the number of users that can be changed may be set in advance to limit the number of new participants recruited. With such a configuration, the organizer who received the participation application does not need to input the change of the number of people, and the control unit directly receives the participation application from the participant and updates the number of people information, so that it is possible to reduce time and effort of the organizer in reservation input.

The foregoing description has been described with reference to specific implementations. However, the illustrative discussions above are not intended to be exhaustive or to limit the claims to the precise forms disclosed. Many variations are possible in view of the above teachings. The implementations were chosen and described to best explain principles of operation and practical applications, to thereby enable others skilled in the art.

The various drawings illustrate a number of elements in a particular order. However, elements that are not order dependent may be reordered and other elements may be combined or separated. While some reordering or other groupings are specifically mentioned, others will be obvious to those of ordinary skill in the art, so the ordering and groupings presented herein are not an exhaustive list of alternatives.

As used herein: the singular forms “a”, “an,” and “the” include the plural forms as well, unless the context clearly indicates otherwise; the term “and/or” encompasses all possible combinations of one or more of the associated listed items; the terms “first,” “second,” etc. are only used to distinguish one element from another and do not limit the elements themselves; the term “if” may be construed to mean “when,” “upon,” “in response to,” or “in accordance with,” depending on the context; and the terms “include,” “including,” “comprise,” and “comprising” specify particular features or operations but do not preclude additional features or operations.

What is claimed is:

1. A system comprising a host device including one or more processors and memory storing one or more programs to be executed by the one or more processors, the one or more programs including instructions for:
receiving, from a first terminal device, first reservation information including a reservation date, a reservation time, and a number of people;
allocating a first rental space based on the reservation date, the reservation time, and the number of people without causing a user of the first terminal device to allocate the first rental space and without sending a notification identifying the first rental space to the first terminal device before a period during which the first reservation information can be changed elapses;
receiving, from the first terminal device, updated reservation information including an updated reservation date, an updated reservation time, or an updated number of people;
allocating a second rental space different from the first rental space based on the updated reservation date, the updated reservation time, or the updated number of people without causing the user of the first terminal device to allocate the second rental space and without sending a notification identifying the second rental space to the first terminal device before a period during which the updated reservation information can be changed elapses; and
upon elapse of the period during which the updated reservation information can be changed, sending a notification identifying the second rental space to the first terminal device.

2. The system of claim 1, wherein the one or more programs further include instructions for:
determining a rental fee for the first rental space based on the number of people included in the first reservation information multiplied by a predetermined amount; and
sending a notification including the rental fee to the first terminal device before the period during which the first reservation information can be changed elapses.

3. The system of claim 2, wherein the instructions for determining the rental fee for the first rental space include instructions for:
determining an allocation rate based on a ratio of allocated rental spaces to a total number of rental spaces;
in accordance with a determination that the allocation rate is higher than a previous allocation rate, increasing the predetermined amount from a previous predetermined amount; and
in accordance with a determination that the allocation rate is lower than a previous allocation rate, decreasing the predetermined amount from a previous predetermined amount.

4. The system of claim 1, wherein the instructions for allocating a second rental space include instructions for adjusting a partition for the first rental space, wherein the second rental space includes at least a portion of the first rental space with the adjusted partition.

5. The system of claim 1, wherein the updated reservation information includes an updated number of people, the updated number of people includes at least one additional person, and the updated reservation information is received from a terminal device associated with the additional person.

6. A system comprising a host device including one or more processors and memory storing one or more programs to be executed by the one or more processors, the one or more programs including instructions for:
receiving, from a first terminal device, first reservation information including a first reservation date, a first reservation time, and a first number of people;
allocating a first rental space based on the first reservation date, the first reservation time, and the first number of people without causing a user of the first terminal device to allocate the first rental space and without sending a notification identifying the first rental space to the first terminal device before a period during which the first reservation information can be changed elapses;
receiving, from a second terminal device different from the first terminal device, second reservation information including a reservation date overlapping with the first reservation date, a second reservation time overlapping with the first reservation time, and a second number of people different from the first number of people;
reallocating the first rental space for a user of the second terminal device based on the second reservation date, the second reservation time, and the second number of people without causing the user of the second terminal device to reallocate the first rental space and without sending a notification identifying the first rental space to the second terminal device before a period during which the second reservation information can be changed elapses; and
upon elapse of the period during which the second reservation information can be changed, sending a notification identifying the first rental space to the second terminal device.

7. The system of claim 6, further comprising:
upon reallocating the first rental space for the user of the second terminal device, allocating a second rental space different from the first rental space for the user of the first terminal device without causing the user of the first terminal device to allocate the second rental space and without sending a notification identifying the second rental space to the first terminal device before a period during which the first reservation information can be changed elapses; and
upon elapse of the period during which the first reservation information can be changed, sending a notification identifying the second rental space to the first terminal device.

8. The system of claim 6, wherein the one or more programs further include instructions for:
determining a rental fee for the first rental space based on the first number of people included in the first reservation information multiplied by a predetermined amount; and
sending a notification including the rental fee to the first terminal device before the period during which the first reservation information can be changed elapses.

9. The system of claim 8, wherein the instructions for determining the rental fee for the first rental space include instructions for:
determining an allocation rate based on a ratio of allocated rental spaces to a total number of rental spaces;
in accordance with a determination that the allocation rate is higher than a previous allocation rate, increasing the predetermined amount from a previous predetermined amount; and
in accordance with a determination that the allocation rate is lower than a previous allocation rate, decreasing the predetermined amount from a previous predetermined amount.

10. The system of claim 6, wherein the instructions for reallocating the first rental space include instructions for adjusting a partition for the first rental space, increasing or decreasing a size of the first rental space.

11. A method, comprising:
at a host device including one or more processors and memory:
receiving, from a first terminal device, first reservation information including a reservation date, a reservation time, and a number of people;
allocating a first rental space based on the reservation date, the reservation time, and the number of people without causing a user of the first terminal device to allocate the first rental space and without sending a notification identifying the first rental space to the first terminal device before a period during which the first reservation information can be changed elapses;
receiving, from the first terminal device, updated reservation information including an updated reservation date, an updated reservation time, or an updated number of people;
allocating a second rental space different from the first rental space based on the updated reservation date, the updated reservation time, or the updated number of people without causing the user of the first terminal device to allocate the second rental space and without sending a notification identifying the second rental space to the first terminal device before a period during which the updated reservation information can be changed elapses; and
upon elapse of the period during which the updated reservation information can be changed, sending a notification identifying the second rental space to the first terminal device.

12. The method of claim 11, further comprising:
determining a rental fee for the first rental space based on the number of people included in the first reservation information multiplied by a predetermined amount; and
sending a notification including the rental fee to the first terminal device before the period during which the first reservation information can be changed elapses.

13. The method of claim 12, wherein determining the rental fee for the first rental space includes:
determining an allocation rate based on a ratio of allocated rental spaces to a total number of rental spaces;
in accordance with a determination that the allocation rate is higher than a previous allocation rate, increasing the predetermined amount from a previous predetermined amount; and
in accordance with a determination that the allocation rate is lower than a previous allocation rate, decreasing the predetermined amount from a previous predetermined amount.

14. The method of claim 11, wherein allocating the second rental space includes adjusting a partition for the first rental space, wherein the second rental space includes at least a portion of the first rental space with the adjusted partition.

15. The method of claim 11, wherein the updated reservation information includes an updated number of people, the updated number of people includes at least one additional person, and the updated reservation information is received from a terminal device associated with the additional person.
